(19) United States
(12) Patent Application Publication
(10) Pub. No.: US 2011/0153800 A1
(43) Pub. Date: Jun. 23, 2011

(54) IDENTITY SHARING METHOD AND APPARATUS IN MOBILE COMPUTING ENVIRONMENT

(75) Inventors: Young-Seob CHO, Daejeon (KR); Jin-Man Cho, Daejeon (KR); Sang-Rae Cho, Daejeon (KR); Dae-Seon Choi, Daejeon (KR); Jong-Hyouk Noh, Daejeon (KR); Soo-Hyung Kim, Daejeon (KR); Seung-Hyun Kim, Daejeon (KR); Kwan-Soo Jung, Daejeon (KR); Deok-Jin Kim, Daejeon (KR); Seung-Hun Jin, Daejeon (KR)

(73) Assignee: ELECTRONICS AND TELECOMMUNICATIONS RESEARCH INSTITUTE, Daejeon (KR)

(21) Appl. No.: 12/972,662

(22) Filed: Dec. 20, 2010

(30) Foreign Application Priority Data
Dec. 21, 2009 (KR) 10-2009-0128384

(51) Int. Cl. G06F 15/173

(52) U.S. Cl. 709/223

(57) ABSTRACT

An identity protocol gate way according to the exemplary embodiments of the present invention includes an artifact generating and inquiring module generating an artifact by receiving a sharing request message from a mobile identity wallet according to a request made by an application program of a mobile device, inquiring corresponding identity information according to a request of the identity information including the artifact from a web server and transferring the inquired identity information to the web server; and a protocol converting module converting the sharing request message into a protocol message of a wired environment by receiving the sharing request message from the mobile identity wallet, transferring the protocol message to the identity web server, transferring sharing response information and the artifact to the application program of the mobile device by using a mobile protocol in response to the sharing response information from the identity web server.

### CROSS REFERENCE TO RELATED APPLICATIONS

This application claims priority to Korean Patent Application No. 10-2009-0128384 filed on Dec. 21, 2009, the entire contents of which are herein incorporated by reference.

### BACKGROUND OF THE INVENTION

1. Field of the Invention

The present invention relates to an identity sharing method and an identity sharing apparatus in a mobile computing environment. More particularly, the present invention relates to an identity sharing method and an identity sharing apparatus using an identity protocol gateway in a mobile computing environment.

2. Description of the Related Art

Recently, with the release of a smart phone, full-browsing can be implemented even under a mobile computing environment, which can provide services like the existing wired Internet environment even under the mobile computing environment. In particular, mobile unique information, such as location information of a user, is transferred to a web site in a mobile computing environment, thereby making it possible to provide customized services to a user.

As one of the existing technologies, Korean patent laid open publication No. 2009-0080000 discloses an LBS-based mobile coupon providing system and method for determining a location of a user mobile terminal using an independent location information management server and providing a mobile coupon service suitable for a user location through the determined location of the user mobile terminal. However, the LBS-based mobile coupon providing method provides only the coupon services and does not disclose a protocol and system transferring general user identity information.

Further, Korean patent laid open publication No. 2009-0068183 discloses an apparatus and method for sharing user control enhanced digital identity capable of enhancing a user control right when a user shares his/her identity information on a web site, in order to share the identity information under a general-purpose computing environment. However, the method for sharing user control enhanced digital identity is operated under a general-purpose computing environment and as a result, does not handle the identity sharing specific for the mobile environment.

Therefore, a need exists for a technology sharing the user identity information in the mobile device to provide the identity information specific for the mobile environment to the existing web server, thereby making it possible to provide user-customized services.

The information disclosed in this Background of the Invention section is only for enhancement of understanding of the general background of the invention and should not be taken as an acknowledgement or any form of suggestion that this information forms the prior art already known to a person skilled in the art.

### SUMMARY OF THE INVENTION

The present invention has been made in an effort to provide an identity sharing method and an identity sharing apparatus in a mobile computing environment capable of sharing user identity information in a mobile device to provide identity information specific for a mobile environment to the existing web server in order to provide user-customized services to a user.

According to an exemplary embodiment of the present invention, there is provided an identity sharing method, including: transferring a sharing request message from a mobile identity wallet to an identity protocol gateway according to a request for sharing user identity information by an application program of a mobile device; generating an artifact and converting the sharing request message into a protocol message of a wired environment which is to be transferred to an identity web server, by the identity protocol gateway; processing the sharing request message in the identity web server to generate sharing response information and transfer the generated sharing response information to the identity protocol gateway; transferring the artifact and the sharing response information to the application program by using a mobile protocol, by the identity protocol gateway; transferring a coupon request message including the artifact to a web server, by the application program; and inquiring the identity information to the identity protocol gateway by using the artifact and transferring the requested coupon to the application program according to the inquired result by the web server.

At the transferring the sharing request message from the mobile identity wallet to the identity protocol gateway, the sharing request message transferred from the mobile identity wallet to the identity protocol gateway may include location information of the mobile device and user preference information.

The generating the artifact and converting the sharing request message into a protocol message may includes: extracting, by the identity protocol gateway, the identity information to be shared from the sharing request message and generating the artifact; and converting, by the identity protocol gateway, the sharing request message into the protocol message for the wired environment and transferring the protocol message to the identity web server.

The transferring the artifact and the sharing response information to the application program by using a mobile protocol may include: confirming, by the identity protocol gateway, the sharing response information and determining whether or not the processing by the identity web server has been carried out successfully; and deleting the identity information and the artifact, which are stored in the storage, if it is determined that the processing by the identity web server has failed.

The identity sharing method may further include transferring a response message informing that the corresponding identity sharing request has failed to the mobile identity wallet.

At the inquiring the shared identity information from the identity protocol gateway by using the artifact in the web server and the transferring the requested coupon to the application program according to the inquired result, the identity protocol gateway searches in the storage whether or not the identity information corresponding to the artifact included in the identity information inquiring request is present according to the identity information inquiring request from the web server and deletes the searched identity information and artifact and transferring the searched identity information to the web server.

According to another exemplary embodiment, there is provided an identity protocol gateway, including: an artifact generating and inquiring module generating an artifact by receiving a sharing request message from a mobile identity wallet according to a request made by an application program of a mobile device, storing an identity and the artifact in storage, inquiring corresponding identity information according to a request of the identity information including the artifact from a web server and transferring the inquired identity information to the web server; and a protocol converting module converting the sharing request message into a protocol message of a wired environment by receiving the sharing request message from the mobile identity wallet, transferring the protocol message to the identity web server, transferring sharing response information and the artifact to the application program of the mobile device by using a mobile protocol in response to the sharing response information from the identity web server.

The sharing request message may include location information of the mobile device and user preference information.

The protocol converting module may confirm the sharing response information and determine whether or not the processing by the identity web server has been carried out successfully.

If it is determined that the processing by the identity web server has failed, the protocol converting module may request the artifact generating and inquiring module in order to delete the identity information and the artifact stored in the storage.

If it is determined that the processing by the identity web server has failed, the protocol converting module may transfer to the mobile identity wallet a response message informing that the identity sharing request has failed.

The protocol converting module may request to the artifact generating and inquiring module a search as to whether or not the identity information corresponding to the artifact included in the identity information inquiring request is present, according to the identity information inquiring request from the web server.

If it is determined that the identity information corresponding to the artifact included in the identity information inquiring request is present, the protocol converting module may request the artifact generating and inquiring module in order to delete the corresponding identity information and the artifact and then transfers the searched identity information to the web server.

As set forth above, according to the exemplary embodiments of the present invention, there is provided the identity sharing method capable of transferring the user identity information to the web server in the mobile device, under the mobile computing environment. As a result, the present invention provides the identity information specific for the mobile environment to the existing web server, thereby making it possible to provide the user-customized services to the user.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic diagram of an identity sharing system using an identity protocol gateway in a mobile computing environment;

FIG. 2 is a diagram showing a mobile identity sharing protocol flow;

FIG. 3 is a diagram showing an identity protocol gateway module;

FIG. 4 is a diagram showing a process in which the identity protocol gateway processes an identity sharing message; and

FIG. 5 is a diagram showing a process in which the identity protocol gateway processes an identity inquiring request of a web server.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, an identity sharing method and an identity sharing apparatus in a mobile computing environment according to the exemplary embodiment of the present invention will be described in more detail.

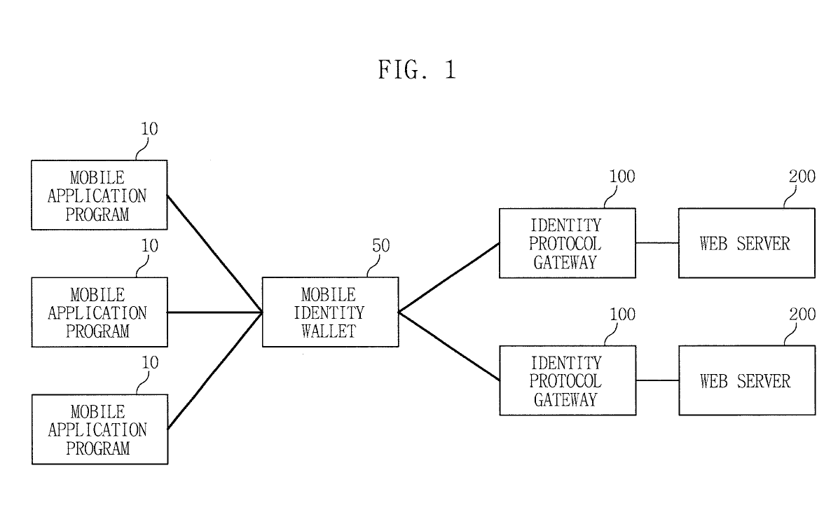

FIG. 1 is a schematic diagram of the environment in which an operation of sharing identity information is performed in a mobile computing environment by using an identity protocol gateway of the present invention.

Referring to FIG. 1, a mobile application program (AP) 10 provides services to a user using an application program executed in a mobile device.

A mobile identity wallet (MIDW) 50 receives a request of the application program AP of the mobile device in order to serve to transfer user identity information to a web server (WS) 200.

An identity protocol gateway (IDPG) 100 serves to transfer the user identity information to the web server 200. In this case, the identity protocol gateway 100 serves to convert a protocol specific for a mobile environment into an identity protocol for a general Internet environment.

The web server (WS) 200 is a service providing server that receives the user identity information as an identity consumer and provides services to a user based on received information.

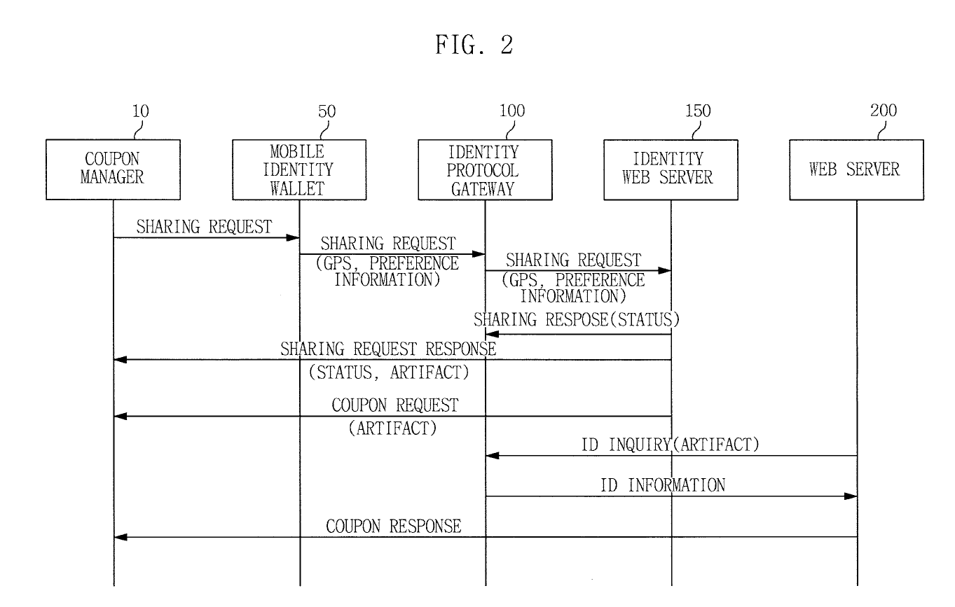

FIG. 2 is a diagram schematically showing a flow of an identity sharing protocol according to the exemplary embodiments of the present invention, which will be described below. In this case, an identity web server (IDWS) 150 is a server providing the user identity information.

Referring to FIG. 2, a coupon manager 10 first requests the sharing of the user identity information (step 1), as an example of the application program AP of the above-mentioned mobile device.

Next, the mobile identity wallet 50 transfers the location information of the user device, i.e., global positioning system (GPS) information and a sharing request message including user preference information to the identity protocol gateway 100 (step 2).

Then, the identity protocol gateway 100 converts the received sharing request message into a protocol message for a wired environment, which is in turn transferred to the identity web server 150 (step 3).

Subsequently, the identity web server 150 processes the sharing request message and then, transfers the processed result to the identity protocol gateway 100 (step 4).

Thereafter, the identity protocol gateway 100 generates an artifact in order to inquire the identity information transferred by the web server 200 and converts the identity information and share response status information into the mobile protocol message and transfers them to the coupon manager 10 (step 5).

Next, the coupon manager 10 transfers the artifact to the web server 200 (step 6).

Then, the web server 200 uses the transferred artifact to inquire the shared identity information from the identity protocol gateway 100 and transfers a coupon to the coupon manager 10 of the user device according to the inquired result (steps 6 to 8).

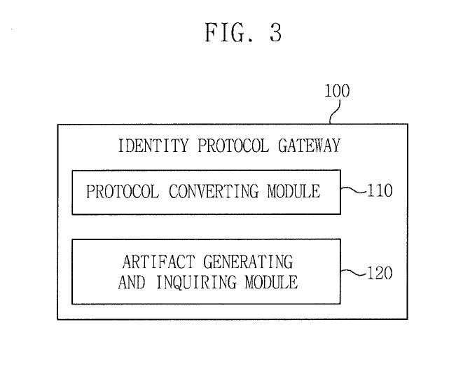

FIG. 3 is a diagram schematically showing a configuration of an identity protocol gateway (IDPG) system according to the exemplary embodiments of the present invention, which will be described below.

Referring to FIG. 3, the configuration of the identity protocol gateway 100 is configured to include a protocol converting module 110 and an artifact generating and inquiring module 120 (hereinafter, referred to as ‘artifact generating and inquiring module’).

The artifact generating and inquiring module 120 generates the artifact by receiving the sharing request message from the mobile identity wallet 50 according to the request of the application program of the mobile device and stores the identity and the artifact in storage. Further, the artifact generating and inquiring module 120 inquires the corresponding identity information according to the request of the identity information including the artifact from the web server 200 and transfers the inquired identity information to the web server 200. The sharing request message includes the location information of the corresponding mobile device and the user preference information.

The protocol converting module 110 converts the corresponding sharing request message into the protocol message for the wired environment by receiving the sharing request message from the mobile identity wallet 50 and transfers the converted protocol message to the identity web server 150. Further, the protocol converting module 110 converts the corresponding share response information and the artifact into the mobile protocol message by receiving the share response information on the sharing request message from the identity web server 150 and transfers the converted mobile protocol message to the application program of the mobile device.

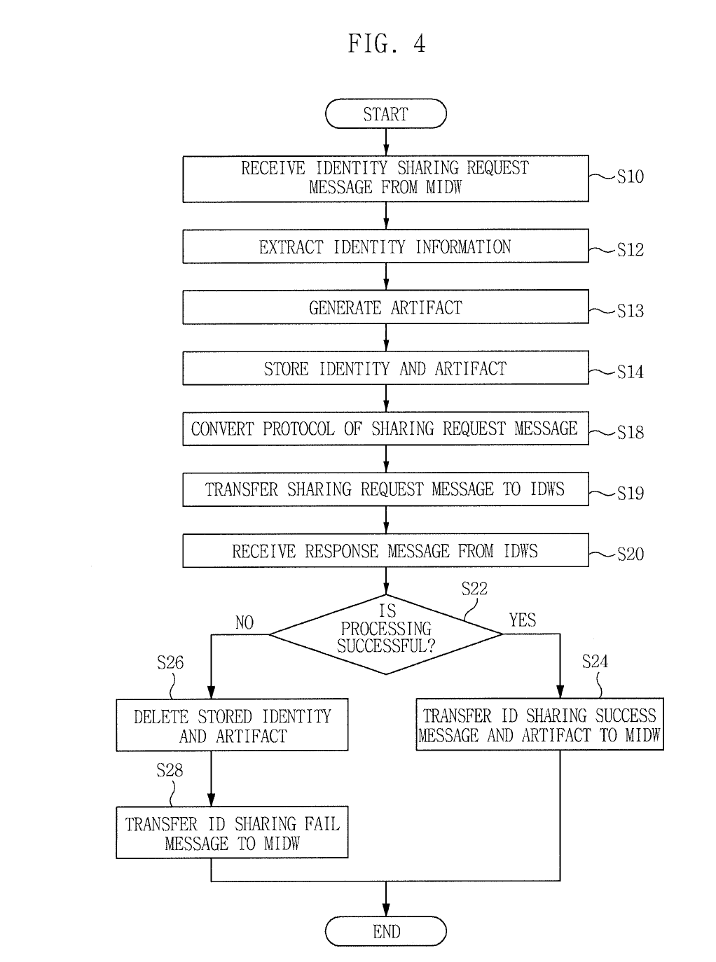

FIG. 4 is a flow chart showing a process in which the identity protocol gateway 100 processes the identity sharing request message transferred from the mobile identity wallet 50, which will be described below.

Referring to FIG. 4, the process first receives the identity sharing request message from the mobile identity wallet (MIDW) (S10).

Next, the process extracts the identity information to be shared from the received sharing request message (S12) and generates at least one random number, i.e., artifact (S13). The process stores the artifact in storage (S14).

Thereafter, the process converts the mobile identity sharing protocol message into the wired identity sharing protocol message (S18).

Then, the process transfers the identity sharing request message to the identity web server (IDWS) (S19) and then, receives the response message from the identity web server (IDWS) (S20).

The process determines whether or not the sharing request is successfully processed through the response message received from the identity web server (IDWS) (S22).

As a result of determination at S22, if it is determined that the processing has been carried out successfully, the process proceeds to S24 and if not, proceeds to S26.

That is, if it is determined that the processing in the identity web server IDWS has been carried out successfully, the process transfers the status information informing that the identity sharing request has been carried out successfully and the response message including the artifact to the mobile identity wallet (MIDW) (S24).

However, if it is determined that the processing in the identity web server IDWS has failed, the process deletes the identity information and the artifact stored in the storage (S26).

Next, the process transfers the response message informing that the identity sharing request has failed to the identity wallet (MIDW) (S28).

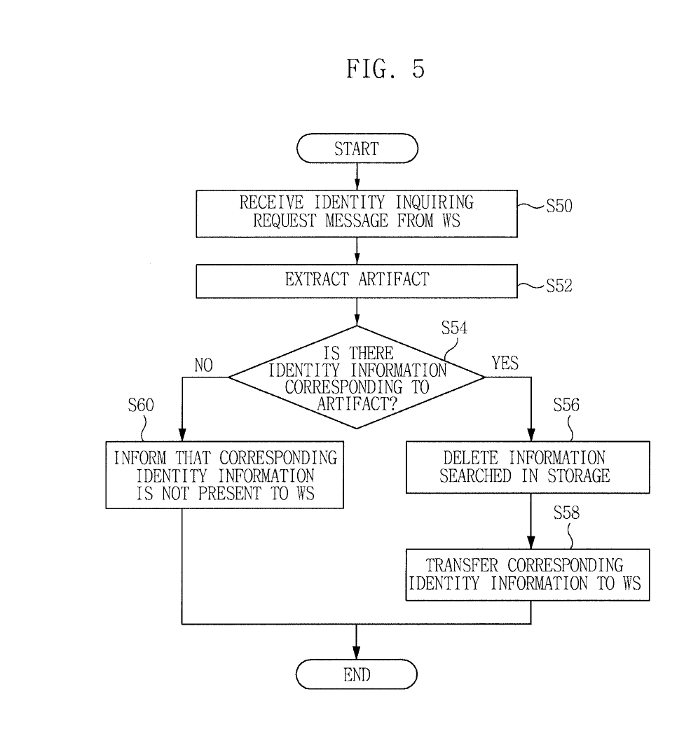

FIG. 5 is a diagram showing a process in which the identity protocol gateway processes the identity inquiring request of the web server.

Referring to FIG. 5, the process first receives the identity inquiring request message from the web server WS.

At step S50, the process extracts the artifact from the request message received from the web server WS (S52).

Next, the process checks whether or not the identity information corresponding to the artifact is present (S54).

If it is determined that the identity information corresponding to the artifact is present, the process proceeds to S56 and if not, proceeds to S60.

That is, if it is determined that the identity information corresponding to the artifact is present, the process deletes the identity information and the artifact, which are searched in the storage (S56). Then, the process transfers the searched identity information to the web server WS (S58).

However, if it is determined that the identity information corresponding to the artifact is not present, the process transfers to the web server WS the fact that the identity information is not present (S60).

As set forth above, the present invention provides the identity sharing method capable of transferring the identity information on a user to the web server in the mobile device, under the mobile computing environment. As a result, the present invention provides the identity information specific for the mobile environment to the existing web server, thereby making it possible to provide the user-customized services to the user.

Some steps of the present invention can be implemented as a computer-readable code in a computer-readable recording medium. The computer-readable recording media include all types of recording apparatuses in which data that can be read by a computer system is stored. An example of the computer-readable recording medium may include a ROM, a RAM, a CD-ROM, a magnetic tape, a floppy disk, an HDD, an optical disk, an optical data storage etc., including a recording medium implemented in the form of a carrier wave (for example, transmission through the Internet). Further, the computer-readable recording media are distributed on computer systems connected through the network, and thus the computer-readable recording media may be stored and executed as the computer-readable code by a distribution scheme.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An identity sharing method in a mobile computing environment, comprising:
transferring a sharing request message from a mobile identity wallet to an identity protocol gateway according to a request for sharing user identity information by an application program of a mobile device;
generating an artifact and converting the sharing request message into a protocol message of a wired environment which is then transferred to an identity web server, by the identity protocol gateway;
processing the sharing request message in the identity web server to generate sharing response information and transfer the generated sharing response information to the identity protocol gateway;
transferring the artifact and the sharing response information to the application program by using a mobile protocol, by the identity protocol gateway;
transferring a coupon request message including the artifact to a web server, by the application program; and
inquiring the identity information to the identity protocol gateway by using the artifact and transferring the requested coupon to the application program according to the inquired result by the web server.

2. The identity sharing method according to claim 1, wherein the sharing request message transferred from the mobile identity wallet to the identity protocol gateway includes location information of the mobile device and user preference information.

3. The identity sharing method according to claim 1, wherein the generating the artifact and converting the sharing request message into the protol message includes:
extracting, by the identity protocol gateway, the identity information to be shared from the sharing request message and generating the artifact; and
converting, by the identity protocol gateway, the sharing request message into the protocol message for the wired environment and transferring the protocol message to the identity web server.

4. The identity sharing method according to claim 3, wherein the transferring the artifact and the sharing response information to the application program by using a mobile protocol includes:
confirming, by the identity protocol gateway, the sharing response information and determining whether or not the processing by the identity web server has been carried out successfully; and
deleting the identity information and the artifact, which are stored in the storage, if it is determined that the processing by the identity web server has failed.

5. The identity sharing method according to claim 4, further comprising transferring a response message informing that the corresponding identity sharing request has failed to the mobile identity wallet.

6. The identity sharing method according to claim 4, wherein the identity protocol gateway searches the storage for the identity information corresponding to the artifact included in an identity information inquiring request according to the identity information inquiring request from the web server and deletes the searched identity information and the artifact after transferring the searched identity information to the web server.

7. An identity protocol gateway, comprising:
an artifact generating and inquiring module generating an artifact by receiving a sharing request message from a mobile identity wallet according to a request made by an application program of a mobile device, storing an identity and the artifact in storage, inquiring corresponding identity information according to a request of the identity information including the artifact from a web server and transferring the inquired identity information to the web server; and
a protocol converting module converting the sharing request message into a protocol message of a wired environment by receiving the sharing request message from the mobile identity wallet, transferring the protocol message to the identity web server, transferring sharing response information and the artifact to the application program of the mobile device by using a mobile protocol in response to the sharing response information from the identity web server.

8. The identity protocol gateway according to claim 7, wherein the sharing request message includes location information of the mobile device and user preference information.

9. The identity protocol gateway according to claim 7, wherein the protocol converting module confirms the sharing response information and determines whether or not the processing by the identity web server has been carried out successfully.

10. The identity protocol gateway according to claim 9, wherein the identity information and the artifact stored in the storage are deleted if it is determined that the processing by the identity web server has failed.

11. The identity protocol gateway according to claim 9, wherein the identity protocol gateway transfers a response message informing that the identity sharing request has failed to the mobile identity wallet if it is determined that the processing by the identity web server has failed.

12. The identity protocol gateway according to claim 7, wherein the protocol converting module requests to search the storage for the identity information corresponding to the artifact included in an identity information inquiring request to the artifact generating and inquiring module, according to the identity information inquiring request from the web server.

13. The identity protocol gateway according to claim 12, wherein the protocol converting module asks the artifact generating and inquiring module to delete the corresponding identity information and the artifact and transfers the searched identity information to the web server if it is determined that the identity information corresponding to the artifact included in the identity information inquiring request is present.
